(19) United States
(12) Patent Application Publication
(10) Pub. No.: US 2010/0299278 A1
(43) Pub. Date: Nov. 25, 2010

(54) Methods for controlling shipment of a temperature controlled material using a spill proof shipping container

(75) Inventors: Richard Kriss, Canby, OR (US); Len Suelter, Birmingham, AL (US); Bret Bollinger, Yorba Linda, CA (US); Peter Berry, Laguna Niguel, CA (US); Ken Carlson, Oro Valley, AZ (US)

Correspondence Address: WAGNER, ANDERSON & BRIGHT, LLP, 3541 OCEAN VIEW BLVD, GLENDALE, CA, 91208, US

(73) Assignee: Cryoport, Inc., Lake Forest, CA (US)

(21) Appl. No.: 12/658,641

(22) Filed: Feb. 4, 2010

Related U.S. Application Data
(60) Provisional application No. 61/150,271, filed on Feb. 5, 2009.

(51) Int. Cl. G06Q 10/00; B65B 63/08; G08B 5/22

(52) U.S. Cl. 705/332; 62/60; 705/333; 340/825.49

(57) ABSTRACT

A shipping container is used with methods for controlling shipment of a temperature controlled material so that once a customer order is initiated with a customer origin point and a customer destination the shipping container with a phase change material maintaining a sample chamber within the shipping container within a desired temperature range is shipped to the customer origin point where a temperature controlled material is loaded into the sample chamber and then the shipping container is shipped to the customer destination and then returned to a repurposing site and periodic location of the shipping container is tracked by use of a wireless location sensor associated with the shipping container during its shipment. The health of the shipping container, as well as the temperature of its sample chamber, can also be monitored, tracked, recorded and retrieved either during shipment or at the conclusion of a shipping cycle.

### CROSS-REFERENCE TO RELATED APPLICATIONS

The present application is a continuation-in part of U.S. application Ser. No. 61/150,271 filed Feb. 5, 2009, entitled “Methods of Controlling a Temperature Controlled Material Using a Spill Proof Shipping Container,” the disclosure of which is specifically incorporated herein by reference.

### FIELD OF THE INVENTION

The present invention is in the field of methods for controlling shipment of a temperature controlled material.

### BACKGROUND OF THE INVENTION

The present invention describes packaging systems for cryogenic shipment of various materials including live cell bio-materials, vaccines, tissues, etc., and various methods for controlling shipments of materials using such a packaging system.

A number of previous patents for cryogenic shippers describe the basic liquid nitrogen container (Dewar) concepts, various concepts for the retention of liquid nitrogen within the cryogenic container, various concepts for closing the opening into the cryogenic container, in which the materials to be shipped are stored, and concepts for external finishing and protection of the cryogenic container.

Much of this technology has been in existence for a number of years; however, many of the problems that have hindered the usage of cryogenic shippers continue to remain today. The packages typically leak liquid nitrogen when laid sideways or when inverted. Packages are often in odd shapes that render them difficult to handle and causes them to consume more volume than desired in the package shipping systems and thereby incur cost penalties.

U.S. Pat. No. 6,467,642 discloses a shipping container that contains many advances over the prior art and identifies a number of problems one faces in shipping Dewars filled with cryogenic materials. It also discloses the construction of Dewars and advances the state of the art with respect to foam included within the inner vessel of a Dewar and its disclosure is specifically incorporated herein by reference to provide a background for the present invention.

And, while U.S. Pat. No. 6,467,642 represents a significant advance in the state of the art of cryogenic shipping containers, further advances are still needed to achieve efficient and economical methods for controlling shipment of temperature controlled materials. It is to this need that the present invention is directed, and the present invention seeks to move this field forward in two ways. First, advances are made to the actual cryogenic shipping containers to address problems found in the prior art as well as to maximize the efficiency of shipping methods using such containers. Second, new methods are disclosed for controlling shipment of such containers. These methods not only seek to increase the efficiency of shipments, but also to increase the reliability and accountability of such shipments, so that the whole field can be advanced to a point that presently does not exist and is not available.

It is significant to note that shipping of temperature controlled materials today usually requires a number of steps that require logistics support which increases cost and the chance for error that can damage the temperature controlled materials during shipping. Due to problems associated with Dewars, it is common practice today to use dry ice for shipping many temperature controlled materials. Because dry ice has a limited holding time of 1-2 days, shipments of longer length or duration require the package to be “re-iced” which creates infrastructure issues usually involving subcontractors and multiple interventions with the packaging. Using dry ice also requires a shipper to source boxes for holding the dry ice and temperature controlled materials as well as sourcing the dry ice. Once this sourcing is complete, the sample must be packaged. Next, pick/up and movement of the sample must be orchestrated and re-icing logistics on international shipments must be managed. As part of the shipping process somebody must also manage the shipment, asking such questions as where is it, did it arrive and was its temperature okay when it arrived. The many drawbacks of this approach include that a customer must coordinate tasks in multiple locations, multiple steps and interventions increase chance of error and international sourcing and material handling can be complex. All of which can create unreliability.

Accordingly, the present invention satisfies another long-felt need by simplifying the logistics, cost and reliability of shipping temperature controlled materials, while also offering methods of shipment that are a true “Green” alternative because dry ice (solid carbon dioxide) is not used, which prevents the release of carbon dioxide into the atmosphere and its impact upon global warming. In addition, the methods disclosed herein provide for new accountability in the shipping process, as well as reliability, and the shipping containers can be re-purposed after each cycle, thus reducing the impact on global landfills. And, due to longer holding times of 10-12 days, the risk of loss during shipment is reduced and, should such loss occur, accountability for the loss can be established.

Finally, the present invention also provides a method for controlling shipment of a temperature controlled material that does not require use of a cryogenic shipper, but does require use of a phase change material added to a shipping container that maintains a sample chamber within the shipping container within a selected temperature range.

### SUMMARY OF THE INVENTION

The present invention is generally directed to a method for controlling shipment of a temperature controlled material implemented in a computer program in which a customer order is initiated with a customer origin point and a customer destination and then a shipping container with a phase change material that maintains a sample chamber within the shipping container within a selected temperature range is shipped to the customer origin point for receipt of a temperature controlled material within the sample chamber and then the shipping container is shipped from the customer origin point to the customer destination and the periodic location of the shipping container can be tracked by use of a wireless location sensor associated with the shipping container during its shipment.

In a first, separate group of aspects of the present invention, the shipping container is also shipped from the customer destination to a repurposing site and the shipping container is packaged in a shipping package with a customer origin point designation (which can be located on a first surface) and a customer destination designation (which can be located on a second surface that is not visible when the first surface is visible so that only one of the two surfaces are visible during a single shipment).

In a second, separate group of aspects of the present invention, the temperature in the sample chamber can be monitored by a wireless temperature sensor during shipment of the shipping container (which may be done by use of a proxy calculation based upon a temperature reading taken outside of the sample chamber) and the temperature can be periodically recorded during shipment and a data log of the temperature in the sample chamber can be extracted either during shipment or after the shipping container has been shipped to the customer destination while an alert can be generated if the temperature in the sample chamber goes above a preselected threshold temperature.

In a third, separate group of aspects of the present invention, periodic health of the sample chamber is determined during shipment of the shipping container (which can be done through use of a wireless sensor) and can be monitored by use of a computer. The periodic location of the shipping container at a given time interval can be used to determine the periodic health of the sample chamber according to at least one preselected criterion and determination of the periodic health of the sample chamber during shipment can utilize at least one variable obtained when the customer order is initiated. Determination of the periodic health of the sample chamber can utilize a measurement of the weight of the shipping container and an alert can be generated if the periodic health is determined to be less than a preselected value. Also, a projected health of the sample chamber at a preselected future time can be used to generate an alert if it is less than a preselected value and, once the alert is generated, either the shipping container can be recharged with an additional quantity of phase change material or any temperature controlled material in the sample chamber of the shipping container can be transferred into a second sample chamber of a second shipping container with a second phase change material that is maintaining the second sample chamber within the second shipping container at a temperature within the desired temperature range.

In a fourth, separate group of aspects of the present invention, a periodic location of the shipping container can be tracked by use of a computer and an identifier associated with the customer order and the delivery transaction can be initiated by accessing a web portal where the customer order is placed.

In a fifth, separate group of aspects of the present invention, there is confirmation of a delivery time of the shipping container at the customer destination and the temperature of the sample chamber at the delivery time.

In a sixth, separate group of aspects of the present invention, a second customer order with a second customer point of origin is obtained and the shipping container is shipped from the customer point of origin to the second customer point of origin before the shipping container is shipped to the customer destination or a second customer order with a second customer destination is obtained and the shipping container is shipped to the second customer destination before the shipping container is shipped to a repurposing site.

Accordingly, it is a primary object of the present invention to provide an improved method for controlling shipment of a temperature controlled material.

This and further objects and advantages will be apparent to those skilled in the art in connection with the drawings and the detailed description of the invention set forth below.

### BRIEF DESCRIPTION OF THE DRAWINGS

FIG. 1 illustrates a cross section of a packaging system for cryogenic shipment oriented in a normal upright vertical orientation whereas

FIG. 2 illustrates the same system in a lateral orientation with an added absorbent layer in the specimen well. In addition, both FIG. 1 and FIG. 2 illustrate fluid flow paths.

FIG. 3 is cross-section view of a two-piece cap for insertion into the neck of the Dewar illustrated in FIG. 1 in which the lower portion of the cap sits in the necktube of the Dewar and an upper portion sits above the necktube and on top of foam insulation.

FIG. 4 is a cross section illustrating a honeycomb insulation used in the inner container of the Dewar for holding liquid nitrogen.

FIG. 5 is an exploded view showing a Dewar as it packaged in a shock absorbing material.

FIG. 6 illustrates a packaging system in condition for shipping and FIG. 6a illustrates the multiple shipping containers within the packaging system shown in FIG. 6.

FIG. 7 illustrates a cross section of an alternative packaging system for cryogen shipment oriented in a normal upright vertical orientation.

FIG. 8 illustrates use of a packaging insert material used for insulation in the packaging system shown in FIG. 8 without a probe unit being shown.

FIGS. 9A-9F illustrate a packaging insert material presently sold under the trademark ExpandOS.

FIG. 10 illustrates an overall web portal architecture useful in the methods of the present invention.

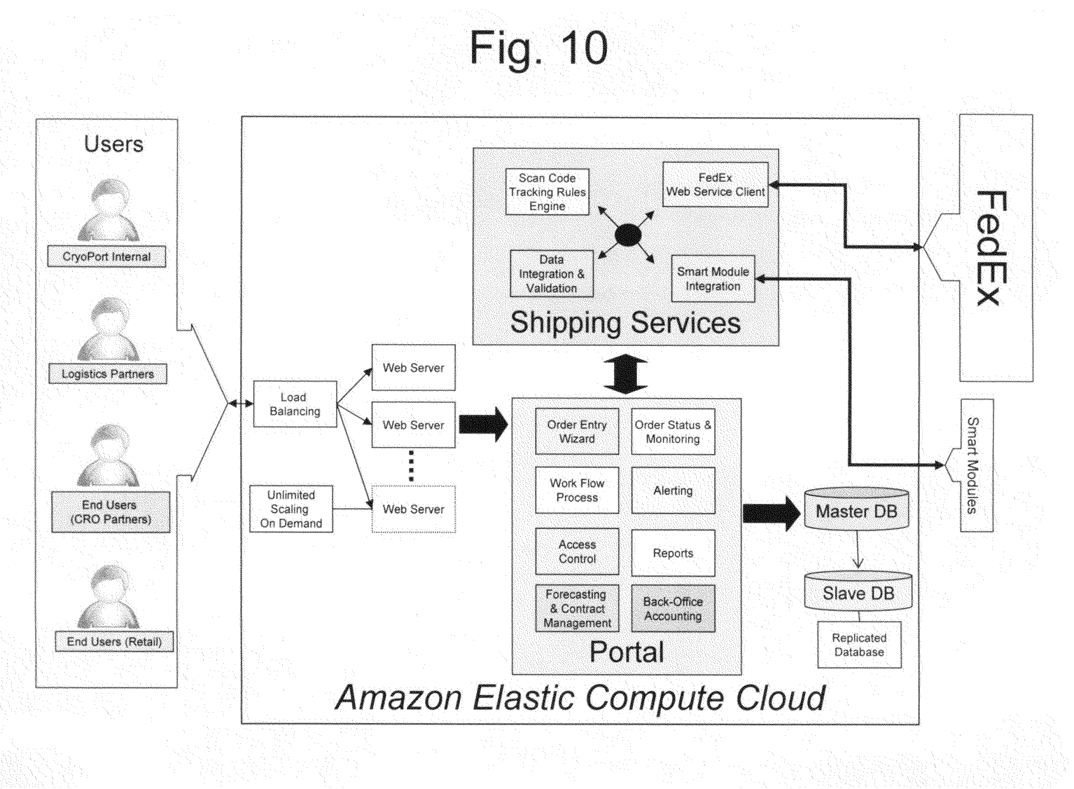

FIG. 11 is a simplified block schematic illustrating a processing system employed in certain embodiments of the invention.

### DETAILED DESCRIPTION OF THE INVENTION

The present invention will now be discussed in connection with an embodiment that uses a packaging system illustrated in the Figures. The packaging system disclosed herein assists in maximizing the efficiency of the methods for controlling shipment of a temperature controlled material also disclosed herein while maximizing the length of time that a liquid refrigerant will maintain a sample chamber within the shipping container at a temperature below a desired maximum temperature.

In one preferred embodiment, the present invention utilizes a cryogenic shipping Dewar system including an improved liquid retention system, an improved liquid absorption system and novel packaging concepts.

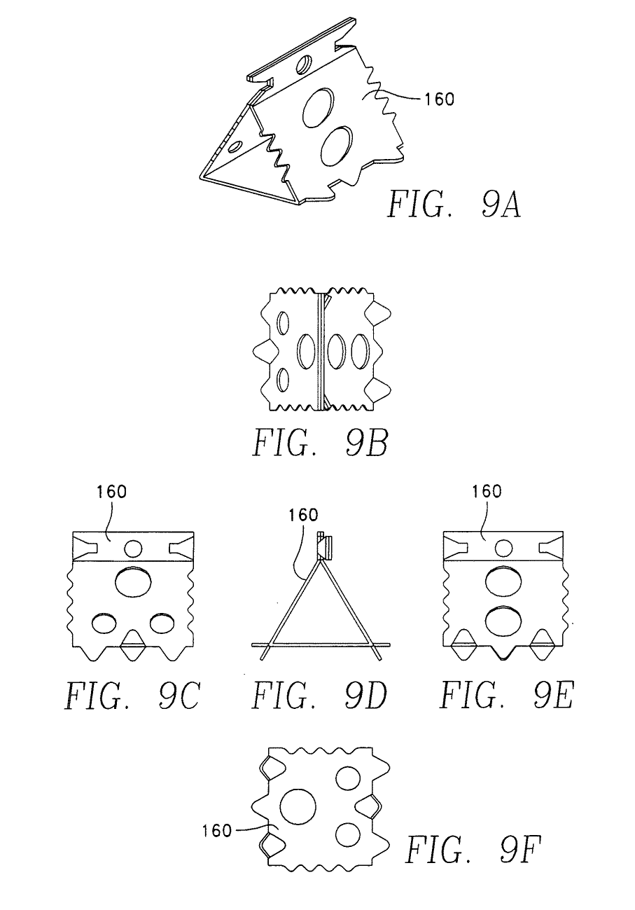

In another embodiment, the present invention utilizes a cryogenic shipping Dewar system that uses packaging insert materials presently sold under the trademark ExpandOS (which are shown in FIGS. 9A-F) for insulation.

A shipping package almost by definition needs to be functional in any position, including both lateral and inverted orientations. This is particularly true of smaller packages that encompass most of the packages that are shipped via package delivery services including parcel post, UPS®, FedEx®, etc. It is these services that are necessarily used if economical, reliable and timely shipment and delivery is required. All currently available cryogenic shipping containers will spill some liquid cryogen if laid on their sides or inverted as one would anticipate happening in the commercial shipping environment. Most of these shipping containers include an internal, primary absorbent material that acts, with varying degrees of efficiency, to inhibit the amount of liquid cryogen that will be spilled; but, none of them completely eliminates every spill potential as all depend on surface tension capillary forces to contain the liquid. Even though the rules and regulations pertaining to commercial shipment preclude any evidence of free liquid, the currently available units that are routinely used for that service do in fact permit some amount of spillage. Thus, there has been a long-felt need to further reduce and/or eliminate the possibility of liquid spillage. The present invention describes a way to satisfy this long-felt need while at the same time enhancing the protection of the liquid nitrogen container from the rigorous shipping environment. The present invention also includes improvements to the internal absorbent material, in the form of a polymeric coating that enhances its durability, reliability and ability to withstand repeated decontamination cycles.

In the Figures and the following more detailed description, numerals indicate various features of the invention, with like numerals referring to like features throughout both the drawings and the description. Although the Figures are described in greater detail below, the following is a glossary of the elements identified in the Figures.
100 Dewar
101a inner shell
101b vacuum insulation
101c outer shell
102 primary absorbent
103 specimen well
103a optional absorbent for specimen well 103
104 necktube
105 foam neckplug
106 shipping carton
107 aperture
108 cushioning material
109 secondary absorbent
110 shipping carton
111 neckplug cap
113 liquid flow path
114 absorbent layer
121 foam disk
122 grommet
123 ribbon
124 Nylon disc
125 extension tube
126 washer
127 fastener
128 sieve pack
140 cardboard packing frame
141 cutout in cardboard packing frame 140
151 electronics unit
152 thermocouple wire
153 tip of thermocouple wire 152
160 ExpandOS™ packaging insert material

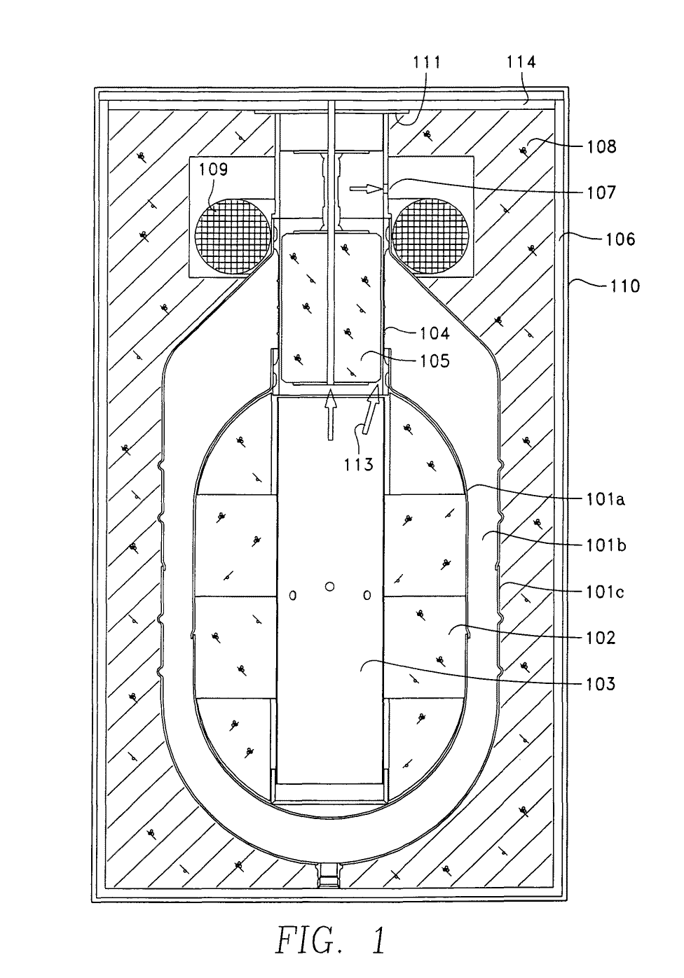

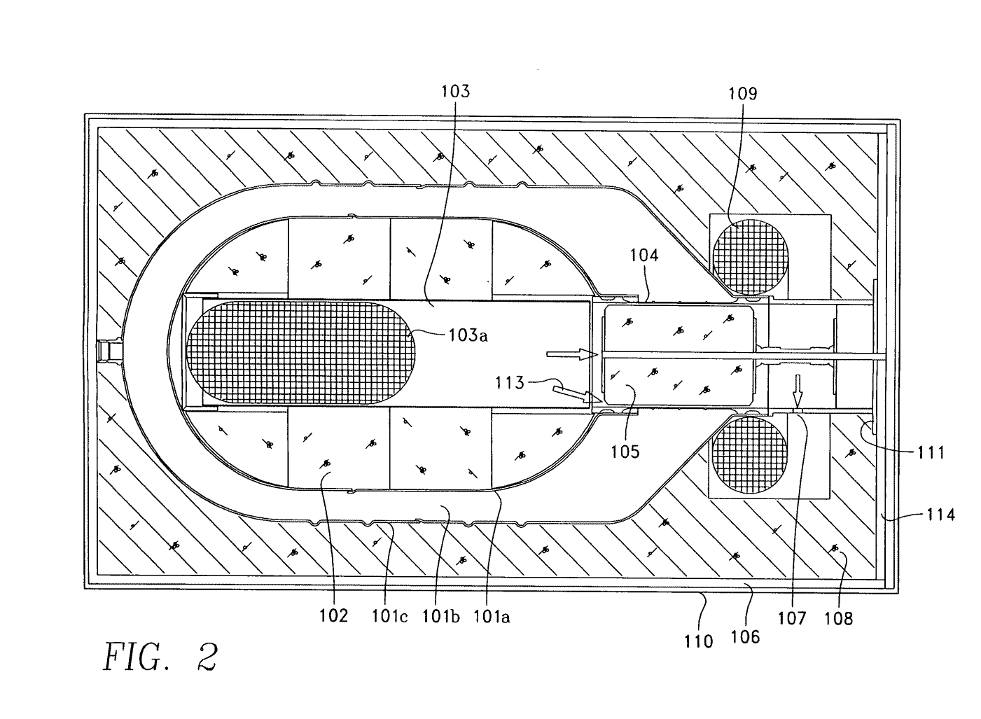

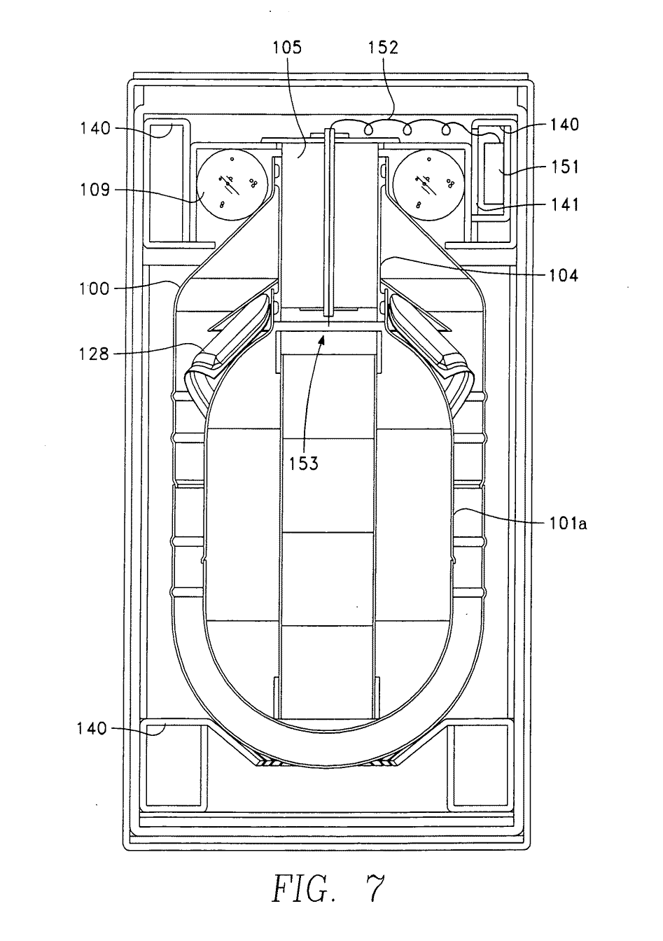

FIG. 1 illustrates a first cryogenic shipping package shown in its normal upright orientation. Items 101a, 101b and 101c show the dual walled cryogenic Dewar 100 that is similar to Dewars described by prior art. A primary absorbent material 102 is included within the inner container for the purpose of capturing and retaining the liquid nitrogen that provides the necessary refrigeration capacity. The absorbent foam is normally an annular shape surrounding a cylindrical specimen well 103 within the Dewar. The specimen well typically has a diameter similar to that of the necktube opening and it typically extends to the bottom of the inner container. Alternately, as illustrated in FIG. 2, optional absorbent material 103a can also fill the lower portion of the inner container, the lower portion of the specimen well, so as to offer increased absorbent capacity but reduced specimen capacity. The inner container of the Dewar is connected to the outer shell by means of a cylindrical necktube 104 that allows access to the product stored within the specimen well. In normal use, the opening through the necktube is closed, or partially closed to the extent that vapor is allowed to escape, with an insulating neckplug 105 that could also be configured to function as a supplemental absorbent. A sieve pack 128 (shown in FIG. 7 but deleted from FIG. 1 for clarity) is located between the dual walled cryogenic Dewar 100 and is cryogenically activated. The external end of the necktube is joined to the outer shell 101c. The area where the parts are joined is typically equipped with a reinforcing flange to protect the joint from impact damage.

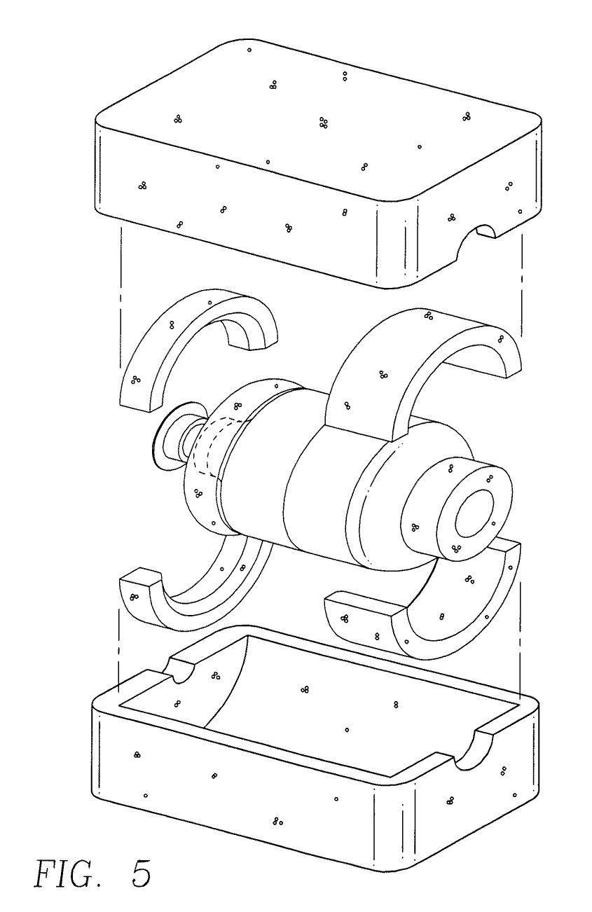

The whole of cryogenic Dewar 100 is encased within a cushioning material 108 constructed of a clamshell pair of shock absorbing foam material such as expanded polystyrene (see FIG. 5). Within the cushioning material, a cavity is formed to provide a collection volume and to encase a secondary absorbent material 109. A simplified version of this arrangement can be made in which the whole of the cushioning material is made of an absorbent material thus eliminating the need for a separately identifiable secondary absorbent. The completed cryogenic shipping package is formed when Dewar 100 and surrounding cushioning material 108 is inserted into a shipping carton 106 that might be constructed of corrugated paper, plastic or other common packaging material. The typical arrangement is a corrugated box with flaps opening at the top to provide access to the neckplug cap 111 which can be grasped to remove the neckplug to gain access to the specimen storage well. This complete package can further be inserted into shipping carton 110 used to protect the whole package during a first leg of shipment.

When the completed package is in the upright orientation, the liquid nitrogen contained therein is situated by gravity at the bottom of the inner container 101a. However, when the package is laterally oriented as in FIG. 2, the liquid will tend to flow referentially to fill the lateral lowest portions of the inner container. If the level of liquid in that orientation exceeds the elevation of the necktube opening into the inner container, some liquid will run out through the annular space between the necktube and the neckplug. Similarly, if the shipping package is vertically inverted some liquid will run out of the container. It is not possible to fully seal the container as that would result in a dangerous pressure rise as the liquid cryogen vaporizes from heat input.

Referring to FIG. 2, the flow of liquid nitrogen from the container is illustrated by arrows 113 along the boundary of the necktube to the neckplug. In this invention, an aperture 107 in the surrounding cushioning structure 108 interrupts the flow path when the liquid nitrogen reaches the external end of the necktube. This aperture preferentially directs the liquid nitrogen toward the secondary absorbent and storage well 109 that captures the liquid and allows it to vaporize before it can reach the outside of the package to escape as free liquid. Additionally, the external end of the neckplug is capped with a disk 111 that acts to block the path of any liquid flow that does not pass through the aperture. A further means of protection is offered by placing an absorbent layer 114 on the top surface of the cushioning structure 108. The combinations of these characteristics effectively prevent liquid cryogen spillage from the completed package.

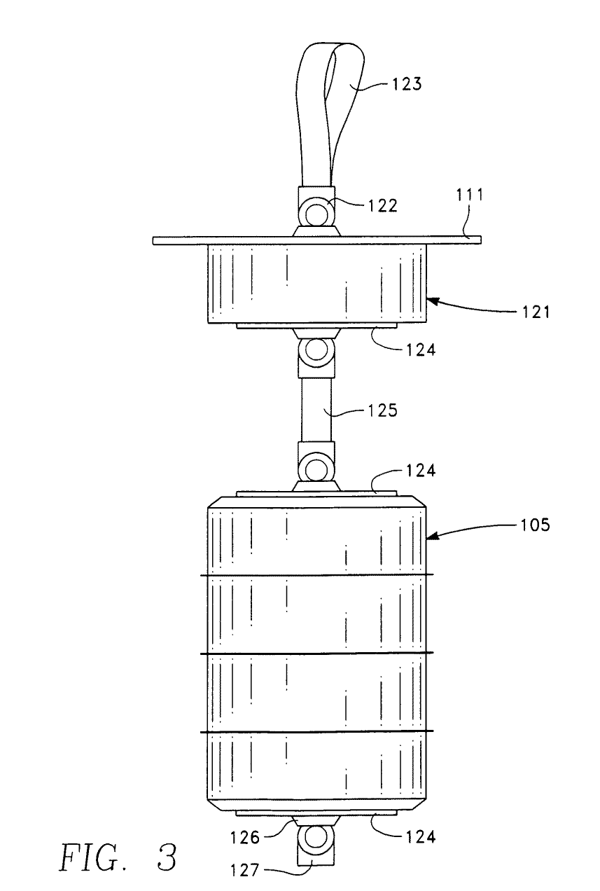

FIG. 3 illustrates a two-piece plug used in a cryogenic shipping package. The lower foam neckplug 105 of the two-piece plug fits down into necktube 104 of Dewar 100 and comes up, essentially, to the top of the necktube. Foam neckplug 105 is held between two Nylon® discs 124. Then, moving up from this plug, there is a flexible extension tube 125 (which can be a cord) that fits within secondary absorbent layer 109 that fits outside necktube 104. Extension tube 125 is affixed to foam neck plug 105 and foam disc 121 which sits inside of packing materials 108 by Nylon® discs 124. Neckplug cap 111 sits atop foam disc 121 and sits atop polystyrene foam packing materials 108 in which Dewar 100 is cushioned inside of the box. Ribbon 123 is connected to the top of neckplug cap 111 by grommet 122 to make it easier to remove the two-piece plug from necktube 104. Thus, the two-piece plug really has one part inside the necktube of the Dewar, an extension sitting outside that goes through the outer absorbent layer, and then an upper piece that fills a hole in the foam packing materials and has an outer cap extending beyond the hole that is necessary to access specimen well 103. The two-piece construction, with its flexible extension tube 125, also helps to prevent breakage of foam neckplug 105 during shipment because it allows Dewar 100 to move laterally without breaking the neckplug; i.e., without compromising the thermal insulating properties of the neckplug.

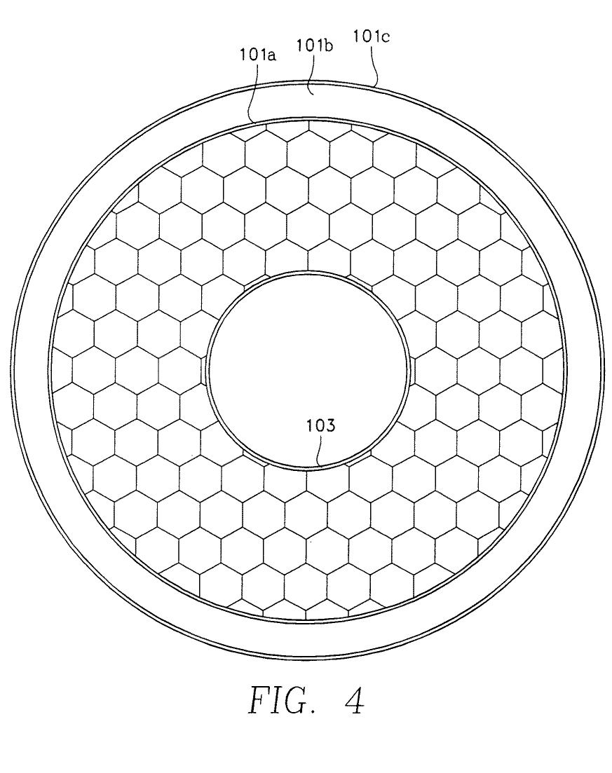

FIG. 4 illustrates an improvement made to the foam material used inside the inner shell 101a in the present invention. As is noted in U.S. Pat. No. 6,467,642, it is desirable that plastic foam inside of inner shell 101a be comprised of at least two foam segments separated by a capillarity separation layer. However, it has been found that it is especially preferred that such foam have a honeycomb structure illustrated in FIG. 4 so that so that the capillary length is not exceeded regardless of orientation, whether the shipper is in a vertical or in a horizontal direction. The honeycomb concept of the foam is not limited to cryogenic applications but will work in any application that relies on capillarity to retain a liquid within a structure and potential applications for this structure include the space program, automotive applications, etc. In addition to the honeycomb structure, the foam coating is specifically a polyurethane isocyanate that is applied to enhance the structural durability of the foam material without materially reducing the volume of liquid absorbed or materially slowing the rate of absorption.

By using the technology described above and in U.S. Pat. No. 6,467,642, shipping containers were constructed in which the holding time validated by an independent laboratory for a frozen temperature of −196° C. was 12+ days when the shipping container was maintained in an upright position and 10+ days when the shipping container was maintained in an inverted position. In addition, such shipping containers have been certified to meet IATA requirements to ship biological and infectious substances and tested in a FedEx® packaging engineering laboratory to meet requirements for global shipping.

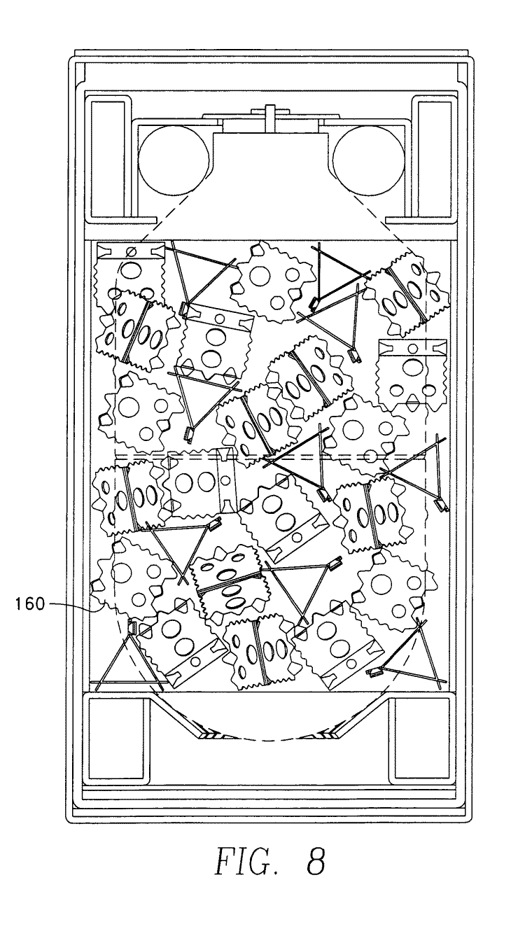

FIGS. 7 and 8 illustrate a second shipping package shown in an upright position. In contrast to the embodiment illustrated in FIG. 1, this package uses a one piece foam neck plug 105. In addition, instead of using environmentally sensitive shipping materials, this package uses a paper based packing system.

The shipping package shown in FIG. 7 uses a cardboard packing frame 140 at the top of the upright package to secure the neck of the Dewar unit and, as shown in FIG. 7, a bottom packing frame can also be used, but it is optional. In addition to cardboard packing frame(s), paper based ExpandOS™ packaging insert materials 160 are used for insulation and shock resistance. The ExpandOS™ packaging insert materials 160 minimize environmental concerns as compared to traditional foam based packaging materials. They also help minimize potential damage to the Dewar through shock dispersion. In addition, due to their structure, the ExpandOS™ packaging insert materials 160 in use become partially crushed or deformed as a packing material, with the result being a non-linear, tortuous path that any leaked cryogenic liquid must travel before it gets to the outside of the shipping package. This tortuous path helps provide time to vaporize leaked liquid cryogen so that it will not reach the outside of the shipping package in a liquid state.

FIG. 7 also illustrates use of an electronics unit 151 coupled with a thermocouple wire 152 for use as a temperature probe, which is discussed in greater detail below. Electronics unit 151 is protected inside a hollow portion of cardboard packing frame 140 and is inserted therein through a cutout 141.

Turning now to the methods of the present invention, in an especially preferred embodiment, the entire ordering and tracking process can be done on-line by use of a computer via the Internet or a computer network through a web portal. Although the methods listed below can also be implemented through telephonic or other connections, the ease, speed and tracking abilities of a computer network connection, as well as the ability to tie into software for use with the present invention, make it more efficient than other connections.

The first step in the shipping process is for a customer to initiate one or more shipments from one or more customer origin points to one or more customer destinations. In its simplest form, a customer can initiate a single order of one shipping package from a single customer origin point to a single customer destination. For example, the customer might be a clinical site that is shipping a patient sample to a lab for testing. Upon initiation of an order, the customer identifies itself and the customer origin point (e.g., a location where the patient sample was obtained and stored awaiting shipment) as well as the location of the lab where the patient sample is to be sent.

When a customer initiates an order certain information is obtained from the customer. This information can include what is to be shipped, the amount of material that is to be shipped, where it will be shipped (as there may be more than one location where material needs to be shipped), the date and time the material will be ready for shipment, an acceptable temperature range at which the material is to be maintained at all times during shipment, and other information that may be needed to comply with customs or other regulations. During the order process software will check to insure that any required shipping containers needed to fulfill the order will be available for the requested shipment date and time and begin the process of managing all shipments needed to fulfill the customer order and return any shipping containers to a repurposing site so that they can be reused. (If required shipping containers are not available, the customer may be prompted to try a different requested shipment date.)

Once a customer order is confirmed and it is confirmed that any shipping container needed to fill the customer order is available, the steps necessary to fulfill the order are initiated. These steps can be broken down broadly into preparing an itinerary of all required shipment legs and placing shipping orders for each shipment leg, preparing any shipping container needed to fill the customer order and shipping it to the customer origin point and tracking the entire shipping process.

Creating an itinerary of necessary shipments allows progress of the shipping container to be tracked and monitored against projected shipping times to help ensure that the shipping container reaches the customer destination while the sample chamber in the shipping container is still being maintained at a temperature below a desired maximum temperature or within an acceptable temperature range. This is especially important because a shipping container charged with a cryogen has a limited lifespan before the cryogen ceases to maintain its sample chamber at a temperature below its desired maximum temperature. Because the itinerary is created before the shipping container reaches the customer origin point, the time needed for each shipping leg can be shortened and the limited lifespan of the cryogen can be maximized by maximizing the efficiency of the various shipments.

For example, once a customer order is placed, and the customer origin point and the date and time the customer's material will be ready for shipment are known, charging of the shipping container with its cryogen (liquid nitrogen) can be timed so that such charging takes place as close as possible to the time when the shipping container will be picked up for shipping by the shipper to the customer origin point as close as possible to the date and time the customer's material will be ready for shipment. When the shipping container arrives at the customer origin point, the customer should already be aware of the anticipated arrival time of the shipping container and be prepared to load the customer's temperature controlled material into the sample chamber of the shipping container and then return the loaded shipping container to a shipper for its next shipping leg. Again, since the time for such activity has already been calculated and anticipated, the order for picking up the shipper has already been placed (and verified), and once the loaded shipping container is picked up at the customer origin point, all that remains is for the shipment to be made to the customer destination according to the order for this shipping leg that was calculated as part of the initial itinerary. Alternatively, the order for picking up the shipper can be placed once delivery to the customer origin point is confirmed.

When the various shipping legs go according to schedule, there should be no problem in delivering the customer's temperature controlled material to the customer destination in accordance with the initial itinerary developed when the customer order is accepted. Also, because of the advance planning that goes into the itinerary, downtimes between shipping events are minimized, which means that there is greater room for error if something does not go according to schedule. Thus, rather than waiting a day or more between delivery of the shipping container to the customer origin point and its pickup, both events can conceivably be done the same day with an appropriate amount of time between them for loading the sample chamber.

In order for the various shipping legs to be done most efficiently, the initial shipping leg to the customer origin point is carefully controlled. Ideally, as already noted, this initial shipping leg is timed so that a shipping container is delivered to the customer origin point with a minimum amount of delay between the time that the shipping container is charged with a cryogen and the time that the shipping container arrives at the customer origin point. In addition, steps can be taken to simplify, speed up and ensure the accuracy of the later shipping legs by pre-printing labels for use on each shipping leg so that no additional shipping labels need to be filled out and so that no errors can be introduced into the shipping process due to incorrect entry of shipping information on a shipping label.

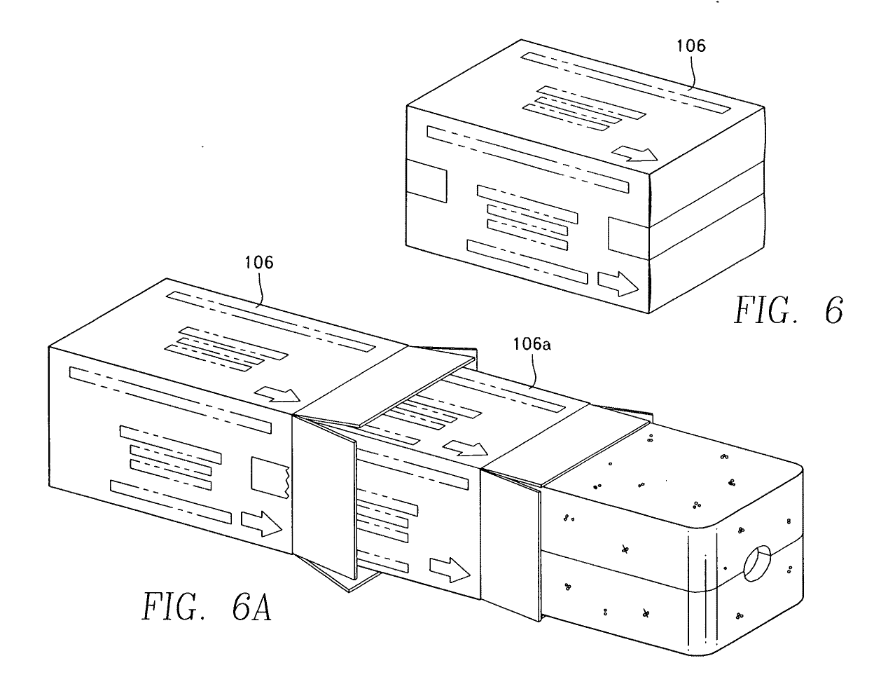

In the shipping packing system shown in FIG. 1, an additional shipping carton is included within the initial shipping container (see FIG. 6A) that contains preprinted shipping labels for each additional shipping leg, and flaps of the carton can be folded so that only one shipping label (for the next shipping leg) is visible at a time. Thus, when the shipping container leaves its original processing site a Dewar is packaged inside of a shipping box and supported within that box by foam packing materials. One flap of this box contains a shipping label for the shipment leg from the customer origin point to a customer destination and another flap of this box contains a shipping label for the return shipment leg from the customer destination to a reprocessing facility. This shipping box, in turn, is then included within a second outer shipping box which is used to ship the shipping container from its original processing site to the customer origin point. When the shipping container arrives at the customer origin point it is opened and the outer box is removed, the sample is inserted into the sample chamber and then the inner box is resealed with the customer destination label showing and it is ready for shipment. When the shipping container arrives at the customer destination point it is opened, the sample is removed, and then it is resealed with the reprocessing facility shipping label showing.

Tracking of the shipping container allows problems in the shipping process to be identified when they arise and, if necessary, steps can be taken to solve such problems. In this sense, tracking of the location of the shipping container can be used to measure the “health” of the shipping container and its sample chamber according to at least one preselected criterion. For example, let us assume that an itinerary for a customer order provides that a shipping container is to be delivered to a customer origin point by 10 a.m. on a given day and it is then to be picked up at the same location at 3 p.m. the same day, but, for some reason, the shipping container is not picked up the same day. When the time for pickup has passed, and there is no confirmation of the pickup, and the shipping container is tracked as still being located at the customer origin point, a new order can be placed for pickup of the shipping container at the customer origin point at a later date and time and any subsequent shipping legs in the order itinerary can be automatically adjusted at the same time by a software itinerary program having access to available shipping information. The new order can be placed automatically or after the reason for deviation from the itinerary has been investigated and it has been determined that the delay will not adversely affect shipment within a new itinerary timeframe for the customer order. Let us now assume that this new order, like the initial order, ends up the same way—with the shipping container again not being picked up at the scheduled pickup time. Let us also assume that repeated delays result in a conclusion that shipment cannot be made within a new itinerary timeframe for the customer order without adversely affecting the sample because the cryogen in the shipping container does not have sufficient useful life left to ensure the temperature of the sample chamber remains below its desired maximum temperature. At this point there are three options for dealing with the problem caused by the delay. The order can be cancelled in its entirety (which may be better than losing the temperature controlled shipment during shipment due to excessive heat in the sample chamber). Alternatively, new cryogen can be added to the shipping container or a new shipping container can be delivered to the customer origin point for use in filling the customer order under a revised itinerary tied to the useful life of the replacement shipping container. Whichever alternative is chosen, the delay will not result in damage to the temperature controlled material during shipping because such material did not leave the customer origin point in a shipping container that would not be able to maintain the temperature of such material below a desired maximum temperature during shipment to the customer destination.

Rather than a delay in pickup at the customer origin point, other delays may occur during shipment after pickup at the customer origin point. For example, the shipping container may be shipped to an improper destination by the shipper or diverted to another location by a regulatory authority, or delay may be caused by unforeseen circumstances, customs authorities or some other regulatory authority. As long as the delay can be detected through knowledge of the location of the shipping container at a given point in time, appropriate steps can be taken, if need be, to deal with such delay. For example, if the shipping container has been misdirected or diverted, an order can be placed for a new shipping leg from the point where the shipping container is now located to the correct destination. Or, as was noted in the earlier scenario where delay occurred at the customer origin point, arrangements could be taken to have new cryogen added to the shipping container or a new shipping container could be delivered to where the shipping container is located due to delay (for example, waiting to clear customs) so that the temperature controlled material can be transferred to the replacement shipping container with a longer useful life that will allow the temperature controlled material to reach the customer destination without damage caused by excessive temperature.

A critical element of the shipping process is the ability to track the location of the shipping container. Such location tracking allows verification of pick-up and delivery and identifies where a shipping container is delayed or to where it might be misdirected or diverted. In one especially preferred embodiment of the present invention such tracking is accomplished by use of a wireless location sensor identified with the shipping container during its shipment. The sensor is uniquely identified with the shipping container and the customer order and can be readily tracked by computer tracking software as its location is detected. Although the location of the sensor might be monitored on a continuous basis during some or all of the shipping process, it need not necessarily be monitored on a continuous basis, so long as it is monitored during key points of the shipping process.

One way that the location of the shipping container might be monitored is to utilize a global positioning system (“GPS”) to determine a precise location of the shipping container at any given time. However, at least at the present time, adding such capability to every wireless sensor will greatly increase its cost. Accordingly, at least until the cost of such technology decreases, the location of the shipping container can be monitored by detecting the wireless location sensor at discreet points along the shipping route at discreet points in time. For example, a customer, such as a large university, biopharma research facility, lab, or the like, could have its own detector while shipping vehicles would also have their own detector. With such a system it would be possible to determine when a shipping container with a wireless location sensor arrives at a customer origin point or destination and identify where it is during the shipping process (e.g., it is located in a FedEx® vehicle that itself can be tracked or at a distribution point, such as a shipping warehouse where deliveries are consolidated and coordinated, or at a particular port of entry in customs). Such a system can avoid the present costs associated with GPS and utilize available infrastructure, such as the FedEx® delivery structure.

To the extent that an independent system is desired, so there is no need to rely upon an existing infrastructure such as FedEx®, an opportunistic wireless tracking system can be utilized. For example, there are many locations that presently offer free WiFi coverage that are located along many routes where a FedEx® delivery truck could be expected to travel, an example of which might be Starbucks® stores. If the wireless location sensor is designed to opportunistically utilize such WiFi hotspots to send its location via the Internet to a central tracking program, interim movement of the shipping container can be tracked and, when such movement is coupled with fixed point detection centers, such as at the customer origin point and destinations, and central warehousing facilities, a good picture of shipping container's location can be obtained, keeping in mind that continuous and instantaneous tracking is not required to accomplish the goals of the shipping methods set forth herein.

It is envisioned that a wireless location sensor used in the present invention can be located within the plug inserted into the necktube of the Dewar in the shipping container. Such location ensures that the location sensor will remain with the Dewar and also allows it to be combined with other sensor functions discussed below. However, care must be taken to protect the sensor from damage that can occur if it comes into contact with liquid nitrogen leaked from the Dewar. In addition, the wireless location sensor will likely need logic and other sensors to allow it to be turned on and off when the shipping container is onboard an airplane because regulations prohibit certain devices from being used during portions of flights such as takeoff and landing.

FIG. 7 illustrates a wireless location sensor made up of electronics 151 and thermocouple wire 152. Thermocouple wire 152 is inserted into foam neckplug 105 with a tip 153 slightly extending beneath the bottom of foam neckplug 105 inserted into necktube 104 of the Dewar. Electronics 151 can include a housing, printed circuit board and electronics components, including a processor, memory and other components such a various sensors and the like. Electronics 151 is electrically connected to thermocouple wire 152.

After the shipping container has been delivered to the customer destination it will be returned to a reprocessing center where it can be conditioned for reuse. To facilitate efficient return to the reprocessing center it is especially desirable that the return leg be included in the itinerary associated with a given customer order, that this return leg with a shipper be booked in connection with the initial customer order (and, if need be, modified when the itinerary is modified) and that a preprinted label for return to the reprocessing center be included with the shipping container. Reprocessing of the shipping container helps to minimize landfill waste and reduce the cost of the overall shipping process. In addition, it can facilitate verification and accountability when a data log stored within the shipping container is downloaded as part of reprocessing, as will be discussed hereinafter.

Because tracking of the location of the shipping container allows the shipping progress to be documented and monitored real time by a computer, it also provides a mechanism for establishing why any delays are incurred in the shipping process and, if necessary, allocating any liability associated with such delays.

The methods described so far might be viewed as an initial or Phase I stage approach in which a web portal with software integrated to a shipper's information technology (such as FedEx) is used to track shipping containers during transit and a combination of shipping container technology and shipping methodology work together to provide a solution that helps shippers of temperature controlled material simplify end-to-end shipping, improve reliability of frozen shipments and implement a “Green” alternative to present shipping methods, all at a reduced total cost. The reduced total cost can be analyzed by comparing the price per shipment of a dry ice shipment with a shipment according to the present invention.

For a dry ice shipment, the shipper must buy the shipper, pay to receive the shipper or ship it to the point of use, buy the refrigerant, pay to receive the refrigerant or ship it to the point of use, pack the shipper with the specimens, arrange for pick up of the shipper, monitor/track the shipper in transit, re-ice the shipper en route, unpack the shipper and remove the specimens, and either dispose of the shipper or arrange for its return. In addition, if the shipper becomes too warm during the shipment, there will be an additional cost associated with loss of the specimens.

For a shipment according to one preferred embodiment of the present invention, the same shipper will only be required to pay a single price, which will be much less than the combined total cost incurred for a dry ice shipment, and packing and unpacking of the shipper will be fast and easy.

On top of all of the advantages that can be obtained by use of the Phase I shipping approach methods already described, additional advantages can be obtained by use of advanced shipping methods.

An advanced shipping method that might be considered a Phase II shipping approach is to implement a data logger on board the shipping container to monitor and periodically record temperature in the shipping container during transit. The data logger can be accessed and a data log removed during shipment of the shipping container and/or once the shipping container is returned to reprocessing facility. Such information could prove especially valuable in dealing with issues relating to liability that might arise if a specimen is damaged during shipment, or in settling questions relating to whether any such damage did in fact occur during shipment. A data logger can be included in electronics 151.

In order to monitor the temperature of the sample chamber of the shipping container the sample chamber itself can be monitored (which presents certain technical challenges) or the temperature in the sample chamber can be monitored by use of a proxy calculation based upon a temperature reading taken outside of the sample chamber. For example, if the temperature reading is taken in the necktube, a simple calculation can be used to calculate what the actual temperature in the sample chamber will be based upon the distance between the sample chamber and the location of the temperature sensor in the necktube.

It is especially preferred that a temperature monitor be a wireless temperature sensor that can be combined with the wireless location sensor. This allows for economy of manufacture and eliminates the need for two separate wireless devices since both devices can be included in one unit such as electronics 151. Moreover, when the temperature and location sensors are integrated into a single unit with data recording, location data can be included with temperature data in the data log.

Once a temperature sensor is included in the shipping container it can also be used to trigger an alert if a rise in temperature is detected or if the temperature in the sample chamber goes above a preselected threshold temperature or outside a preselected temperature range. This function is one way in which the “health” of the shipping container can be monitored and tracked, especially if it is combined with a location of the shipping container, since the periodic location of the shipping container itself at a given time interval can be used to determine the periodic health of the sample chamber according to at least one preselected criterion such as, for example, anticipated remaining time required for the shipping container to reach a customer destination. An alert can also be generated upon detection of a trend predicting that the temperature in the sample chamber will exceed a preselected threshold temperature within a predetermined time.

A further advanced shipping method that might be considered a Phase III shipping approach is to utilize a smart chip on board the shipping container to monitor location, temperature and state of health via wireless tracking using a web portal. Use of a smart chip opens up many different possibilities, especially when a data log function is included. For example, when the shipping container is first shipped and its cryogen is, essentially, fully charged, its weight can be recorded and then subsequent measurements of weight can be used to calculate how much cryogen has been discharged and then, based upon the cryogen remaining, calculate the expected life of the remaining cryogen charge. Knowing the rate of discharge of the cryogen can also be used to compare anticipated discharge against actual discharge and then use the actual rate of discharge to recalculate remaining life of charge.

A smart chip on board of the shipping container can be combined with wireless sensing technology and data logging to open up new possibilities regarding monitoring and data acquisition. Indeed, data can be acquired from outside of the shipping container itself, such as from an opportunistic network discussed above, that can then be used for other purposes. The smart chip can be included in electronics 152.

So far the shipping methods disclosed herein have been limited to situations in which a single customer origin point ships to a single customer destination. However, much greater efficiency can be obtained if multiple customer origin points and/or customer destinations are included within a single cycle of the shipping container beginning with the point of origin of the shipping container in which it is charged with a cryogen and ending with arrival of the shipping container at a reprocessing facility. Thus, for example, let us assume that a particular customer has multiple locations where samples are located that are going to the same customer destination, or multiple customers are shipping to the same customer destination, or a customer is shipping samples to multiple destinations, or multiple customers located at different points within a given location are shipping samples to different points within a second given location (where the location is a city, state, country or other geographic region). In all such scenarios, as long as the health of the shipping container is sufficient to accommodate additional shipping legs, the additional shipments can be made within a single cycle of the shipping container as long as the various shipping legs are properly coordinated. In other words, the shipping method can be extended from a simple shipping method beginning with a single point of origination to a single customer origin point to a single customer destination to a single repurposing site to an N leg shipping plan in which the number of shipping legs N is opportunistically determined based upon customer orders and health of the shipping container. Furthermore, if a shipping container still has additional health remaining after it has been shipped to its final customer destination, it might be used locally to collect different customer samples for consolidation in a new shipping container that is beginning its own shipping cycle. Of course, in all such scenarios, the shipping labels on the packaging of the shipping container would have to be adjusted to accommodate the additional shipping legs, or certain shipping legs might not utilize preprinted shipping labels already affixed to the shipping container.

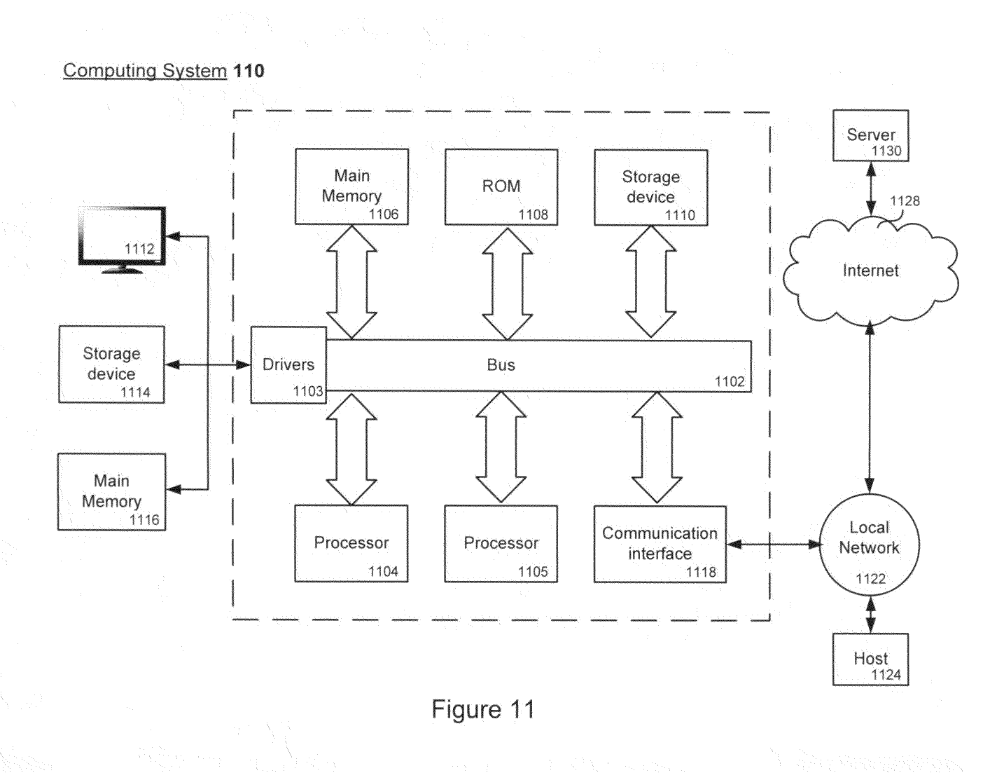

With reference to FIG. 11, certain methods of the invention can be implemented through use of a computer or a computer network and certain embodiments of the invention employ a processing system that includes at least one computing system 110 deployed to perform certain of the steps described above. Computing system 110 can comprise a commercially available system that executes commercially available operating systems such as Microsoft Windows®, UNIX or a variant thereof, Linux, a real time operating system and or a proprietary operating system. The architecture of the computing system may be adapted, configured and/or designed for integration in the processing system. For example, a computing system might comprise a bus 1102 and/or other mechanisms for communicating between processors, whether those processors are integral to the computing system 110 or located in different, perhaps physically separated subsystems, and device drivers 1103 may provide output signals used to control internal and external components.

A computing system 110 suitable for use in the present invention typically comprises memory 1106, 1116 that may include one or more of random access memory (“RAM”), static memory, cache, flash memory and any other suitable type of storage device that can be coupled to a bus 1102 or other communication mechanism. In some embodiments, memory 1106 and one or more processors 1104, 1105 may be fabricated in a common device and/or collocated in a common package. Memory 1106, 1116 can be used for storing instructions and data that can cause one or more of processors 1104 and/or 1105 to perform a desired process. Main memory 1106 may be used for storing transient and/or temporary data such as variables and intermediate information generated and/or used during execution of the instructions by processor. Some computing systems 110 may comprise one or more separate non-volatile storage device 114, such as read only memory (“ROM”), flash memory, memory cards or the like; non-volatile storage 114 may be connected to the bus 1102 or other communication mechanism, but may equally be connected using a high-speed universal serial bus (USB), Firewire or other such bus that is coupled to the bus 1102 or other communication mechanism. Non-volatile storage 114 can be used for storing configuration, and other information, including instructions executed by processors 1104 and/or 1105. Non-volatile storage 114 may also include a mass storage device, such as a magnetic disk, optical disk, and/or flash disk that may be directly or indirectly, temporarily or semi-permanently coupled to the bus 1102 or other communication mechanism and used for storing instructions to be executed by processors 1104 and/or 1105, as well as other information.

Computing system 110 may provide an output for a display system 1112, typically in a control panel. In some embodiments, display system may comprise one or more of an LCD flat panel display, a touch panel display, electroluminescent display, plasma display or other display device that can be configured and adapted to receive and display information to a user of the computing system. Typically, device drivers 1103 can include a display driver, graphics adapter and/or other modules that maintain a digital representation of a display and convert the digital representation to a signal for driving a display system 1112. The computing system 110 may also include logic and software to generate a display signal provided to a remote terminal or different computing system. An input device can be provided locally or through a remote system. It will be appreciated that input and output can be provided from and to a wireless device such as a PDA, a tablet computer or other system suitable equipped to display the images and provide user input.

Certain embodiments of the invention provide host systems as well as deployable electronic tags that include a computing system 110, albeit having different capacities and capabilities. One system may generate a shipping order using a process performed by a computing system 110 in which a processor executes one or more sequences of instructions. For example, such instructions may be stored in main memory 1106, having been received from a computer-readable medium such as a storage device 1114. Execution of the sequences of instructions contained in the main memory 1106 causes one or more processors 1104 and/or 1105 to perform process steps according to certain aspects of the invention. In certain embodiments, functionality may be provided by embedded computing systems that perform specific functions wherein the embedded systems employ a customized combination of hardware and software to perform a set of predefined tasks. In one example, an alert may be generated upon detection of a trend predicting that the temperature in a sample chamber will exceed a preselected threshold temperature or temperature range within a predetermined time. In this example, once periodic location and temperature data are received based upon input from, for example, an opportunistic network connection, the data is saved in memory 1106 or 1116 and then used to determine the periodic health of the sample chamber according to at least one preselected criteria. Criteria can include at least one variable obtained when the customer order is initiated. If an alert is generated, another combination of hardware and software might be used to notify a monitoring agent (which may or may not be a person) or to generate corrective action. Thus, embodiments of the invention are not limited to any specific combination of hardware circuitry and software.

The term “computer-readable medium” is used to define any medium that can store and provide instructions and other data to a processor, particularly where the instructions are to be executed by a processor and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to a processor or remotely, typically by use of network connection. Non-volatile storage may be removable from computing system, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of a computing system. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by a processor. For example, the instructions may initially be retrieved from a magnetic disk of a remote computer and transmitted over a network or modem to a computing system. The instructions may optionally be stored in a different storage or a different part of storage prior to or during execution.

A computing system may include a communication interface that provides two-way data communication over a network that can include a local network, a wide area network or some combination of the two. For example, an integrated services digital network (ISDN) may used in combination with a local area network (LAN). In another example, a LAN may include a wireless link. A network link typically provides data communication through one or more networks to other data devices. For example, a network link may provide a connection through a local network to a host computer or to a wide are network such as the Internet. A local network and the Internet may both use electrical, electromagnetic or optical signals that carry digital data streams.

A computing system can use one or more networks to send messages and data, including program code and other information. In the Internet example, a server might transmit a requested code for an application program through the Internet and may receive in response a downloaded application that provides for the anatomical delineation described in the examples above. The received code may be executed by a processor.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for tracking objects in motion and/or transit. In some of these embodiments, the object comprises a shipping container. In some of these embodiments, the object comprises a vehicle that transports products and materials. Typically, the object encounters networks at various points while in transit. The object may be interrogated by devices connected to the network upon establishment of connection between the object and the network. In some embodiments, the object may also proactively transmit information through the network upon determining presence of a suitable network and negotiating a connection with the network. The object may transmit information using standard and proprietary network protocols in a connection-based or connectionless mode of operation. The object may use telecommunication networks to send, for example, short messages and/or units of data.

In some of these embodiments, the object comprises an environmentally controlled container. For example, a temperature-controlled chamber may be provided within the container. Temperature may be controlled by any combination of electrothermal, electrochemical and/or electromechanical means. In some embodiments, liquid nitrogen may be used to maintain a desired temperature of the chamber.

Certain embodiments comprise systems and methods for monitoring remaining cooling capacity of the container. Remaining cooling capacity can be calculated based on battery charge, available liquid nitrogen, ambient temperature and other factors. In some of these embodiments, remaining life can also include an assessment of one or more of the following: the amount of time a container, flask and/or Dewar is in a tilted orientation, the amount of shock and acceleration to which the object and/or container is exposed, ambient temperatures, the weight of the object, volume of the chamber, contents of the chamber and estimates of these factors. In some of these embodiments, a visual indication of the condition and remaining life may be displayed on the object.

Certain embodiments of the invention provide systems and methods for operating an environmentally controlled chamber. The object may include a processing device or a machine readable storage device that enables a processor maintain and receive pre-programmed instructions determining power control associated with the object. In some of these embodiments, on/off times may be specified that anticipate future availability of opportunistic network connections. In some of these embodiments, requirements may be specified that determine when to record a sensor parameter. The instructions may be generated based on a comparison of observed data compared to an analysis of historical information gathered by other monitoring devices traversing a similar route to the object in transit. The route may lie between cities, states and countries. The route may equally lie between points in a building.

In some of these embodiments, a control device provided in the object can decide when the device must not transmit, e.g. when aboard an airplane. In some of these embodiments, on/off determination is accomplished by means of an analysis of elapsed time, location (see location), in response to monitored sensor inputs (temp, altitude, vibration, vibration, RF frequency detection (speech, jet engines, machinery etc.), exposure to magnetic fields, orientation, presence or absence of (i) light or lighting with detectable characteristics (i.e. Kelvin), or absence thereof, and (ii) by external commands provided via magnetic, infrared or RF communications, or the detection of certain RF frequencies or determination of certain network address.

In some of these embodiments, location of the object may be determined at various points during transit. A monitoring system may determine or infer the location of an object by correlating identifiable information in a wireless emission or transmission (RF, infrared, magnetic etc), which has a known and previously determined location. This may be accomplished by means of a single received transmission and/or by a series of related and/or unrelated emissions and/or transmissions. A monitoring system may further determine or infer the location of an object by correlating scan code information provided by handlers of the object or by third parties. Scan code information typically comprises actual location information or location identifications made by inference or deduction from scan code information and/or the fusion of scan code information with other sensor or network information.

In some of these embodiments, a monitoring system may determine or infer the location of an object using a global positioning system (GPS), by RFID “readers” at pre-positioned “choke points” and/or by cellular network triangulation. In some of these embodiments, a monitoring system may determine or infer the location of an object within a building or finite area by means of an analysis of Received Signal Strength Indications (RSSI) or Time Differential of Arrival (TDOA) from one or more transceivers.

In some of these embodiments, a monitoring system may determine or infer the location of an object using an estimate of where the object should be based on the time elapsed since the object departed its point of origin. In some of these embodiments, a monitoring system may determine or infer the location of an object by observing the number of “hops” and duration of each hop, in a shipment as defined by a barometer detecting ascension to altitude.

In some of these embodiments, data can be collected from a plurality of objects in transit using one or more networks. The process of information gathering or data harvesting from these objects will be referred to here as “data backhaul.” Data may be harvested by means of a continuous wireless network (WLAN) connection such as GPRS or WiMAX, for example and/or through purpose-built data collection agents placed in third party (e.g. customer or partner) locations and at strategic “choke-points” along the route of a shipping lane.

In some of these embodiments, data may be harvested by means of opportunistic network connections. Opportunistic harvesting may occur (i) when the object senses the availability of a temporary or transient LAN or PAN agents at any time during their journey, (ii) when two or more objects exchange information among each other (ad-hoc) such that the first object that reaches a network connection uploads information from all other objects it encountered in its journey, and (iii) through mobile data collection agents which come in proximity to an object. Mobile data collection agents may be purposefully mounted on a vehicle or worn by a person or animal.

Certain embodiments of the invention provide a portal for monitoring, tracking and controlling objects in transit. The portal may be deployed in a network “cloud” such that available computing resources can be quickly scaled for performance or deployed in a geographically diverse manner for reliability. The portal may be designed for load-balancing and fault-recovery such that a failing server is removed from service and the remaining “twin” assumes 100% of the processing load until service an be restored. Certain portals may provide real-time monitoring of system internals, and services to detect any stoppage of the system and alarm notification upon such detection. In some of these embodiments, a wizard is provided to assist with data entry: in-grid editing may be provided to simplify data entry and validation of information on a per-field instead of a per-form basis.

In some of these embodiments, automatic generation of customs and regulatory documentation that will accompany the shipment can be provided, thereby eliminating the need for the customer to prepare such documentation in connection with complex shipments. Some of these embodiments comprise programmatic creation of a “Shipping Plan” which contains all of the necessary steps and shipping procedures to complete the order, essentially constructing a work-flow model or required steps to completion. Some of these embodiments comprise methods for Analyzing scan codes to determine if a shipment is progressing according to the dates and milestones expected by the shipping plan. Some of these embodiments comprise “learning” features which can operate by means of analysis of scan codes over time so as to “profile” a shipping lane and comparing actual versus expected shipping activities and details.

Some of these embodiments provide a system that is capable of to programmatically re-issuing repeat orders in response to data entry selections. Moreover, the system may be capable of programmatically generating an invoice to the customer or business partner, for all services covering all legs contained within a single order.

Some of these embodiments provide exception handling and management. Exception analysis is a continuous process of statistically calculating or analyzing observed sensor readings, locations and scan codes over time so as to construct a learned “profile” of the shipping lane that represents the typical, mean, average, best or worst conditions observed of the lane as measured by time, sensor readings, network information and location. The system can programmatically infer that a shipping anomaly has occurred based on comparing observed data with historical profiles, and internal “rules” are applied to the observed versus expected information to determine if an exception has occurred and if human intervention is required.

In some embodiments, exceptions can be inferred when any data received from the device or vendor system is believed to be un-correlated with respect to expected values as determined by prior analysis and inferences derived from similar shipments, over identical or similar routes, with like objects and their contents.

Certain embodiments of the invention provide systems and methods for tracking objects in transit. Some embodiments comprise measuring at least one environmental condition experienced by an object in transit. Some of these embodiments comprise detecting the presence of an adjacent network accessible by the object. Some embodiments comprise transmitting information associated with the object through the network in response to detecting an adjacent network. In some of these embodiments, the transmitted information includes an object identification and a history of measurements of the environmental condition.

In some of these embodiments, the step of detecting is performed after the object is moved from a first location to a second location. Some of these embodiments comprise determining that the object has been moved based on a loss of connection with the adjacent network. Some of these embodiments comprise identifying the physical location of the object, wherein the step of transmitting information includes transmitting an identification of the physical location. Some of these embodiments comprise identifying the physical location of the object is based on information maintained by a component in the adjacent network. In some of these embodiments, identifying the physical location of the object is performed by a tracking device attached to the object. In some of these embodiments, the step of transmitting information is performed by the tracking device. In some of these embodiments, the tracking device includes a wireless sensor configured to perform the detecting step.

In some of these embodiments, the object is a shipping container comprising a temperature controlled chamber accessed through an opening and wherein the tracking device is attached to a plug that seals the opening. In some of these embodiments, the object is a shipping container comprising a temperature controlled chamber accessed through an opening and wherein the tracking device is attached to a plug that seals the opening. In some of these embodiments, the at least one environmental condition includes a measured temperature within the temperature controlled chamber and the measured temperature is determined by a sensor that protrudes from a bottom surface of the plug a predetermined distance into the chamber. In some of these embodiments, the at least one environmental condition includes a plurality of temperatures within the temperature controlled chamber, wherein at least some of the plurality of temperatures are calculated based on the measured temperature and a table of temperature gradients.

In some of these embodiments, the history of measurements comprises measurements obtained at a selected sample rate. Some of these embodiments comprise comparing the history of measurements with a set of expected measurements, wherein the history of measurements. Some of these embodiments comprise generating an alarm when the history measurements deviate from the expected measurements by more than a maximum tolerance value. In some of these embodiments, the sample rate is adjusted based on the time separation of corresponding expected measurements.

In some of these embodiments, the weight of the object is determined by a sensor mounted in an engineered cavity in the bottom of the container so as to provide a stable weight measurement when the box is not seated in an upright orientation. In some of these embodiments, the weight of the object is used to calculate remaining amount of refrigerant and the useful life of the cold storage remaining. In some of these embodiments, the weight of the Dewar is determined from automated scan code information received from a shipping company, and the remaining life of the Dewar is calculated accordingly.

Some of these embodiments comprise electronics and sensors attached or integrated into a monitoring device. In some of these embodiments, the at least some of the electronics and sensors are encapsulated into a plug that fits into the neck of a chamber (e.g. of a Dewar). In some of these embodiments, a temperature sensor protrudes a short distance from the bottom of the plug into a space cavity above the contents of the chamber. In some of these embodiments, temperature of the contents is determined with reference to a table of gradients.

In some of these embodiments, monitoring device may enter periods of over or under sampling in response to the need to record information with more resolution or fidelity. In some of these embodiments, a ship profile is loaded into the device at the time of shipment, and the progress of the shipment is monitored and alarms are generated in response to deviations from expected observations. In some of these embodiments, this information and analysis may be accomplished solely by the device, by the portal or in combination of the two working together.

Certain embodiments of the invention provide systems and methods in which a web portal controller automatically schedules a pickup for a next leg in the ship plan in response to a determination from scan code or other sensor data that a previous leg has been delivered, and where the time elapsed between the two can be varied by the customer or portal.

Certain embodiments of the invention provide systems and methods for tracking an object while the object is in transit. Some of these embodiments comprise providing a shippable object with an electronic tag. In some of these embodiments, the electronic tag is configured to periodically measure at least one environmental condition experienced by the shippable object. In some of these embodiments, the electronic tag is configured to detect the presence of one or more networks accessible by the electronic tag. In some of these embodiments, the electronic tag is configured to transmit information associated with the shippable object through the at least one accessible network when at least one accessible network is detected. In some of these embodiments, the transmitted information includes an identification of the shippable object and a history of at least one measurement of the environmental condition. In some of these embodiments, accessible networks include WiFi, cellular and satellite networks. In some of these embodiments, accessible networks include networks having no encryption and/or password protection. In some of these embodiments, accessible networks include networks for which encryption keys and/or passwords are available to the electronic tag.

In some of these embodiments, presence of one or more accessible networks is detected after the shippable object is moved from a first location to a second location. In some of these embodiments, the electronic tag is configured to determining that the shippable object has been moved based on a loss of connection with a previously accessible network. In some of these embodiments, detecting the presence of one or more networks includes detecting a network accessible to the electronic tag while the shippable object is in transit between two physically remote locations. In some of these embodiments, the electronic tag is further configured to identify a physical location of the shippable object associated with each measurement of the environmental condition. In some of these embodiments, transmitting the information includes transmitting physical locations associated with measurements. In some of these embodiments, the shippable object comprises a shipping container having a temperature controlled chamber and wherein the electronic tag comprises a wireless sensor. In some of these embodiments, the at least one environmental condition includes a temperature of the temperature controlled chamber. In some of these embodiments, the history of measurements comprises measurements obtained at a selected sample rate.

Some of these embodiments further comprise comparing the history of measurements with a set of expected measurements. Some of these embodiments comprise generating an alarm when the history of measurements deviates from the set of expected measurements by more than a maximum tolerance value. In some of these embodiments, the sample rate is adjusted based on a preselected variable and the physical location is identified based on identity of the at least one accessible network.

While the invention has been described herein with reference to certain preferred embodiments, those embodiments have been presented by way of example only, and not to limit the scope of the invention. Additional embodiments and further modifications are also possible in alternative embodiments that will be obvious to those skilled in the art having the benefit of this detailed description. For example, once a smart chip with a wireless transmitter is included in the shipping containers used according to the methods described herein, the smart chip and wireless transmitter could be used for many additional purposes unrelated to actual shipment of temperature controlled materials. As another example, the N leg shipping plan set forth herein could be adopted for other logistical supply chains. Additionally, since the shipping methods described herein are especially well suited for automation via computer software, additional features could be provided by such software. As an example, computer software could be used to generate forms needed for customs and to comply with regulatory authorities and to complete such forms based upon the contents of material to be shipped obtained during the ordering process. Moreover, the shipping methods described herein can be adapted for use with shipping containers that do not use a cryogen, but which control the temperature of a specimen chamber by use of a phase change material that maintains a sample chamber within the shipping container within a selected temperature range in response to the at least one temperature parameter. For example, a solid material at room temperature (25° C.) that changes to a liquid might be used to control the temperature of a specimen chamber being shipped to an especially hot or cold destination.

Accordingly, still further changes and modifications in the actual concepts described herein can readily be made without departing from the spirit and scope of the disclosed inventions as defined by the following claims.

What is claimed is:

1. A method of controlling shipment of a temperature controlled material, wherein the method is implemented in a computer system comprising one or more processors configured to execute one or more computer program modules, the method comprising:
executing, on the one or more processors of the computer system, one or more computer program modules configured to communicate with electronic storage media that stores values for a customer order with a customer origin point, a customer destination and at least one temperature parameter;
causing a phase change material to be added to a shipping container that maintains a sample chamber within the shipping container within a selected temperature range in response to the at least one temperature parameter and shipping said shipping container to the customer origin point; and
causing the shipping container to be shipped from the customer origin point to the customer destination;
wherein a periodic location of the shipping container is tracked by use of a wireless location sensor associated with the shipping container during its shipment.

2. The method of claim 1, further comprising causing the shipping container to be shipped from the customer destination to a repurposing site.

3. The method of claim 1, wherein temperature in the sample chamber can be monitored by a wireless temperature sensor during shipment of the shipping container.

4. The method of claim 3, wherein a data log is created of temperature in the sample chamber during shipment of the shipping container from the customer origin point to the customer destination.

5. The method of claim 3, wherein an alert is generated if temperature in the sample chamber goes outside a preselected threshold temperature range during shipment of the shipping container from the customer origin point to the customer destination.

6. The method of claim 5, wherein the alert is generated upon detection of a trend predicting that temperature in the sample chamber will go outside the preselected threshold range within a predetermined time.

7. The method of claim 1, further comprising determining a periodic health of the sample chamber during shipment of the shipping container to the customer destination.

8. The method of claim 7, further comprising monitoring the periodic health of the sample chamber during shipment of the shipping container to the customer destination.

9. The method of claim 1, further comprising using electronics to estimate a remaining useful life of the phase change material chamber during shipment of the shipping container from the customer origin point to the customer destination by use of a weight variable associated with said shipping container.

10. The method of claim 1, further comprising executing, on the one or more processors of the computer system, one or more computer program modules configured to generate a shipping plan which automatically schedules a pickup for each successive leg in the shipping plan responsive to receipt of confirmation that the corresponding previous leg has been delivered.

11. A method for tracking an object in transit, comprising:
providing a shippable object with an electronic tag that is configured to:
periodically measure at least one environmental condition experienced by the shippable object;
detect the presence of one or more networks accessible by the electronic tag; and
responsive to detecting at least one accessible network, transmitting information associated with the shippable object through the at least one accessible network,
wherein the transmitted information includes an identification of the shippable object and a history of at least one measurement of the environmental condition.

12. The method of claim 11, wherein presence of one or more accessible networks is detected after the shippable object is moved from a first location to a second location.

13. The method of claim 11, the electronic tag is further configured to determine when the shippable object has been moved based on a loss of connection with a previously accessible network.

14. The method of claim 11, wherein detecting the presence of one or more networks includes detecting a network accessible to the electronic tag while the shippable object is in transit between two physically remote locations.

15. The method of claim 14, wherein the electronic tag is further configured to identify a physical location of the shippable object associated with each measurement of the environmental condition, wherein the transmitting the information includes transmitting physical locations associated with measurements.

16. The method of claim 15, wherein the shippable object comprises a shipping container having a temperature controlled chamber and wherein the electronic tag comprises a wireless sensor.

17. The method of claim 16, wherein the at least one environmental condition includes a temperature of the temperature controlled chamber.

18. The method of claim 17, wherein the history of measurements comprises measurements obtained at a selected sample rate.

19. The method of claim 18, further comprising:
comparing the history of measurements with a set of expected measurements; and
generating an alarm when the history of measurements deviates from the set of expected measurements by more than a maximum tolerance value.

20. The method of claim 19, wherein the sample rate is adjusted based on a preselected variable and the physical location is identified based on identity of the at least one accessible network.
